(19) United States
(12) Patent Application Publication
(10) Pub. No.: US 2012/0084932 A1
(43) Pub. Date: Apr. 12, 2012

(54) CLEANSER-HOSTING WIPER HEAD AND CLEANING DEVICE THEREOF

(76) Inventor: Chia-Ching Lin, Taipei City (TW)

(21) Appl. No.: 12/900,023

(22) Filed: Oct. 7, 2010

(51) Int. Cl. B08B 1/00

(52) U.S. Cl. 15/104.93

(57) ABSTRACT

A wiper head includes a cleanser-hosting pouch, a pulling-tab, an anti-leaking layer, and at least one wiper layer. The edges of the cleanser-hosting pouch are sealed for containing liquid cleanser therein, and a pull-tab is attached to a tear-able exit portion on one of the sealed edges. The cleanser-hosting pouch, the pulling-tab, and the anti-leaking layer are disposed between the first wiper layer and the second wiper layer. The anti-leaking layer, the first wiper layer, and the second wiper layer are joined together in forming at least one fixing portion for affixing to the cleaning device. The cleanser can be released from the cleanser-hosting pouch and infiltrates one of the wiping surfaces. The other wiping surface is used for drying the wetted floor or wall surface. Hence, the wiper head pocesses both wet and dry cleaning capabilities. The instant disclosure also provides a cleaning device utilizing the cleanser-hosting wiper head.

### BACKGROUND OF THE INVENTION

1. Field of the Invention

The instant disclosure relates to a cleanser-hosting wiper head; more particularly, to a cleanser-hosting wiper head and cleaning device thereof.

2. Description of the Related Art

For cleaning purposes, a wetted mop or a wiping rag is often used. The inconveniences include preparing a water bucket or a detergent holder, going to and fro the water or detergent source, and unable to access clean water or detergent locally whenever in need.

Please refer to FIG. 9, which shows a conventional cleaning device. The cleaning device has a hollowed holder 10a for supplying the cleaning agent onto a catch pan 11a. The catch pan 11a has a plurality of thru holes 12a, which let the cleaning agent to pass downward onto a sponge 13a. The sponge 13a is bounded underneath by a cleaning rag 14a, which is wrapped around the roller 15a and 16a. The rag 14a is made of water-soaking material for absorbing the cleaning agent. Structurally, such cleaning device is very complex and occupies much space. In addition, the device must be connected to an external cleaning agent in causing inconvenience.

Please refer to FIG. 10, which shows another conventional cleaning device. The cleaning device comprises a holder 20a having a base 21a, which can accommodate a tube 22a of the cleaning agent. The cleaning agent is sent to the wiping member 23a at the bottom end of the holder 20a. Such cleaning device also has a complex structure and occupies much space, in addition to an external supply of the cleaning agent.

To address the above issues, the inventor proposes the following solution.

### SUMMARY OF THE INVENTION

The object of the instant disclosure is to provide a cleanser-hosting wiper head and cleaning device thereof. The major characteristics are light-weight, structurally simplified, easy-to-use, and quick release of the cleanser onto the wiper for moping and wiping purposes.

The other object of the instant disclosure is to provide a cleanser-hosting wiper head and cleaning device thereof, where the cleanser is quickly and evenly released.

Yet, the other object of the instant disclosure is to provide a cleanser-hosting wiper head and cleaning device thereof, which can be used for both wetting and drying the surface.

To achieve the above object, the instant disclosure provides a cleanser-hosting wiper head, which comprises a cleanser-hosting pouch having sealed edges for sealing the internal cleanser; a pulling-tab with one end attached to the sealed pouch; an anti-leaking layer attached to one side of the pouch; a first wiper layer, and a second wiper layer. The pouch, the pulling-tab, and the anti-leaking layer are located in between the first and second wiper layer. The anti-leaking layer, the first wiper layer, and the second wiper layer are joined together and having at least one fixing portion.

The instant disclosure also provides a cleaning device, which comprises a wiper head as described above; a head unit; and a shaft unit. The head unit is connected to one end of the shaft unit, and the wiper head wraps around the head unit, with the fixing portion secured to the head unit.

For advantages, the wiper head of the instant disclosure can be used for moping or sweeping applications. The wiper head is structurally simplified, light-weight, easy-to-use, and accommodates the pouch. The cleanser can be evenly and quickly released in soaking the first wiping layer to serve any cleaning purposes.

The instant disclosure can further include a second wiper layer to provide drying capability as well.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure

### BRIEF DESCRIPTION OF THE DRAWINGS

FIG. 1 shows a perspective view of a cleanser-hosting wiper head of the instant disclosure.

FIG. 2 shows an exploded view of a cleanser-hosting wiper head of the instant disclosure.

FIG. 3 shows an exploded cross-sectional view of a cleanser-hosting wiper head of the instant disclosure.

FIG. 4 shows a schematic view of a cleanser-hosting wiper head in use.

FIG. 5 shows a perspective view of a cleanser-hosting wiper head of another embodiment of the instant disclosure.

FIG. 6 shows a perspective view of a cleaning device of the instant disclosure.

FIG. 7 shows a perspective view of a cleaning device of another embodiment of the instant disclosure.

FIG. 8 further shows a perspective view of a cleaning device of another embodiment of the instant disclosure.

FIG. 9 shows a perspective view of a cleaning device of prior art.

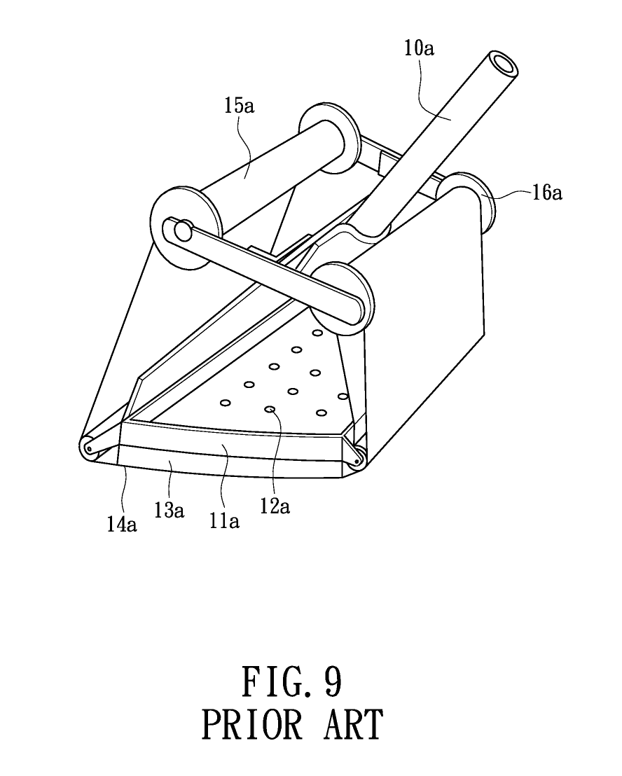

FIG. 10 shows a perspective view of another cleaning device of prior art.

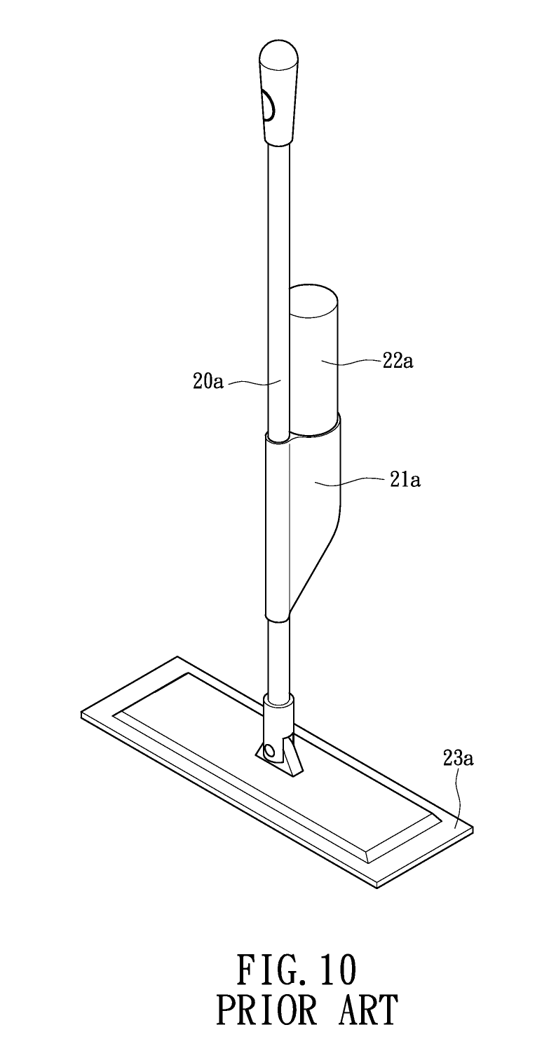

### DETAILED DECRIPTION OF THE PREFERRED EMBODIMENTS

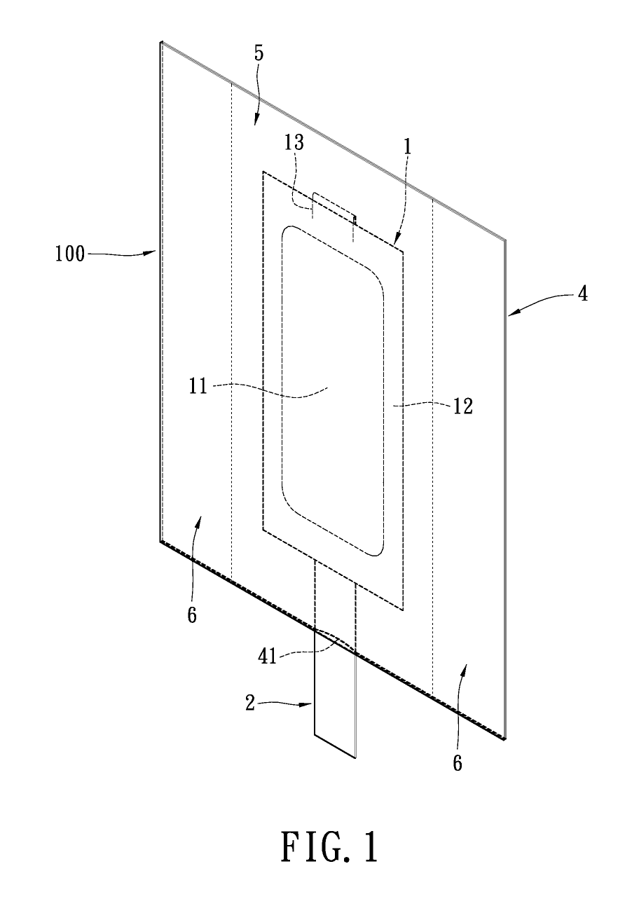

As shown in FIGS. 1 to 4, the instant disclosure provides a cleanser-hosting wiper head 100, which comprises a cleanser-hosting pouch 1, a pulling-tab 2, an anti-leaking layer 3, a first wiper layer 4, and a second wiper layer 5. The cleanser-hosting pouch 1 is bag-shaped, where the internal cleanser 11 may be water or any detergent in liquid or cream/gel-like form.

In the instant embodiment, the cleanser-hosting pouch 1 is made of polyvinyl chloride (PVC), polyethylene terephthalate (PET), nylon, or aluminum foil materials. The material selection is not restricted but based on the property of the internal cleanser 11. For the instant embodiment, the cleanser-hosting pouch 1 is made by overlapping two square-shaped layers. The number of overlapping layer is not restricted, even a single layer is adequate. Once aligned, the layers are joined together on three sides by ultrasonic welding or other sealing methods. The cleanser 11 is then injected before sealing the fourth side of the pouch 1. The four sealed edges 12 ensure the cleanser 11 is securely enclosed within the cleanser-hosting pouch 1.

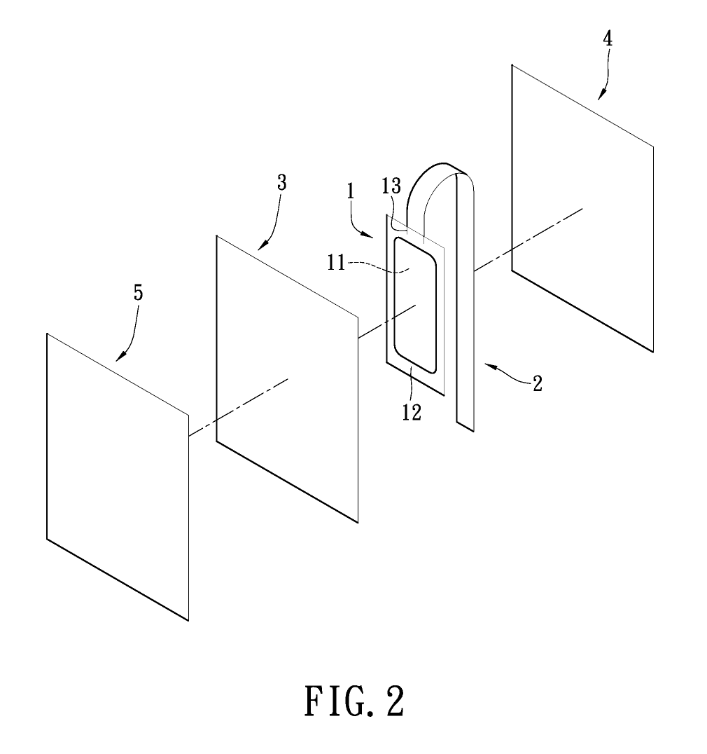

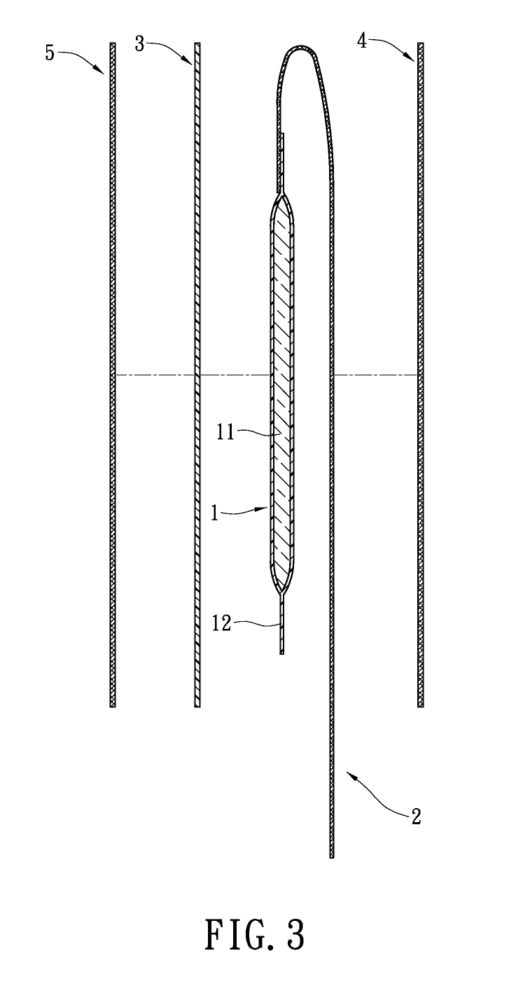

As illustrated in FIGS. 2 and 3, the pulling-tab 2 is attached on one end to the sealed edge 12 of the cleanser-hosting pouch 1 by ultrasonic welding or other joining methods. Two tear-able liquid exit portions 13 are located on the sealed edge 12 attached to the pulling-tab 2. The tear-able liquid exit portions 13 can be parallel or in angled positions. The pulling-tab 2 is bended and extends outward from the cleanser-hosting pouch 1, where the user can pull and twist the pulling-tab 2 to open the cleanser-hosting pouch 1 via the tear-able liquid exit portions 13. Besides welding together, the pulling-tab 2 can also be formed integrally with the cleanser-hosting pouch 1 as one piece.

The anti-leaking layer 3 is made of water-proof material. For the instant embodiment, the anti-leaking layer 3 is made of water-proof nonwoven fabrics, where the area of the anti-leaking layer 3 is greater than the area of the cleanser-hosting pouch 1. The cleanser-hosting pouch 1 is attached to the anti-leaking layer 3 on one side by ultrasonic welding or other methods.

The first wiper layer 4 and the second wiper layer 5 are made of porous materials for wiping. In the instant embodiment, the first wiper layer 4 and the second wiper layer 5 are made of nonwoven fabrics. The thickness of the wiper layer is chosen based on application. Both the first wiper layer 4 and the second wiper layer 5 are shaped correspondingly to the anti-leaking layer 3. The cleanser-hosting pouch 1, the pulling-tab 2, and the anti-leaking layer 3 are disposed in between the first wiper layer 4 and the second wiper layer 5. Specifically, the cleanser-hosting pouch 1 is located in between the anti-leaking layer 3 and the first wiper layer 4.

Meanwhile, the first wiper layer 4, the second wiper layer 5, and the anti-leaking layer 3 are joined on the edges by ultrasonic welding, sewing, etc. Notably, a seam 41 is left between the first wiper layer 4 and the anti-leaking layer 3 near the pulling-tab 2. The seam 41 allows the pulling-tab 2 to extend outward from the cleanser-hosting pouch 1 and be pulled by the user.

Once the anti-leaking layer 3, the first wiper layer 4, and the second wiper layer 5 are joined together, the joined edges form at least one fixing portion 6 for affixing to the mop or other cleaning tools in forming a cleaning device. For the instant embodiment, a fixing portion 6 is formed on the first wiper layer 4 and the second wiper layer 5. Notably, the number and location of the fixing portion 6 is not restricted.

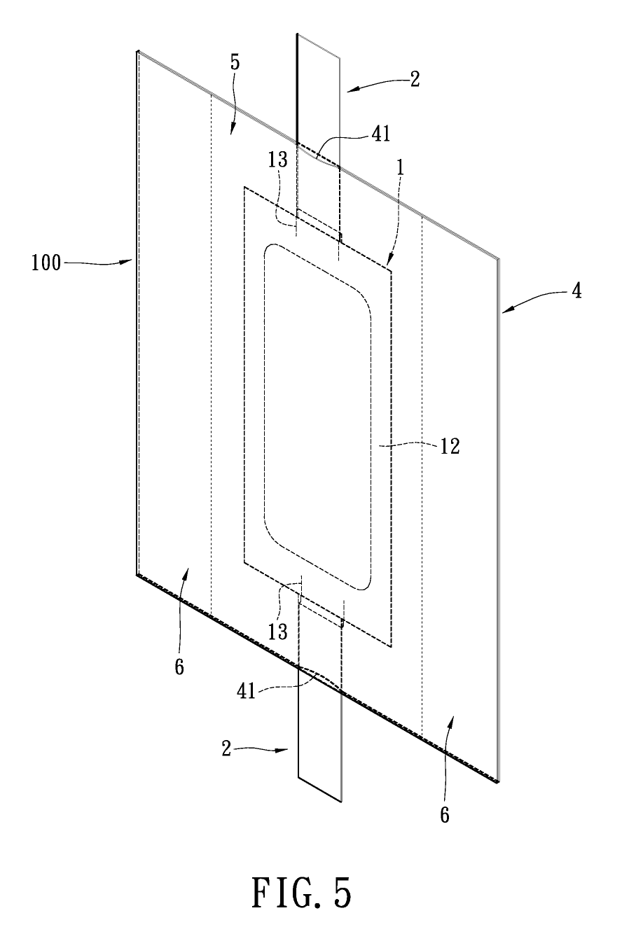

As shown in FIG. 5, the instant disclosure can further include another pulling-tab 2. The addition allows the user to pull and twist both pulling-tabs 2, which tear open the cleanser-hosting pouch 1 in two locations for faster release of the cleanser 11.

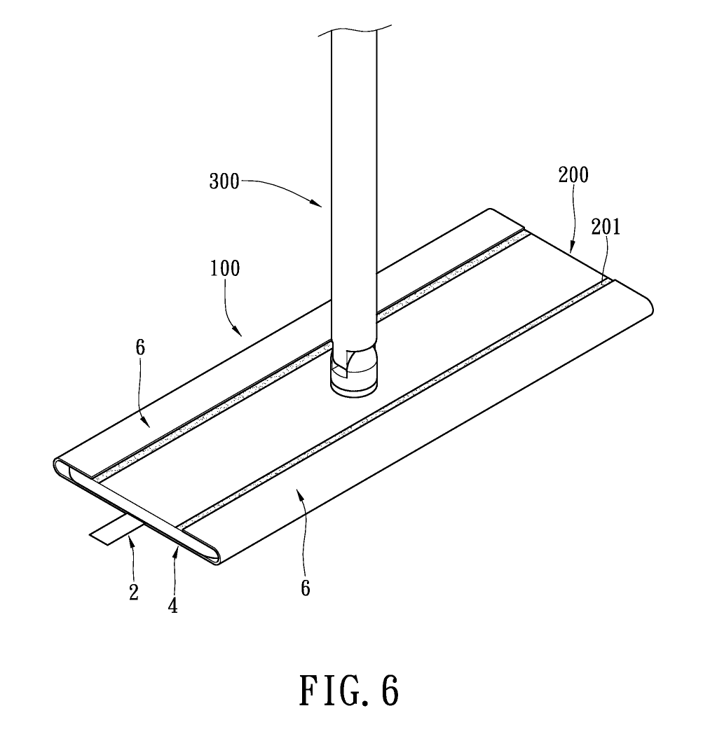

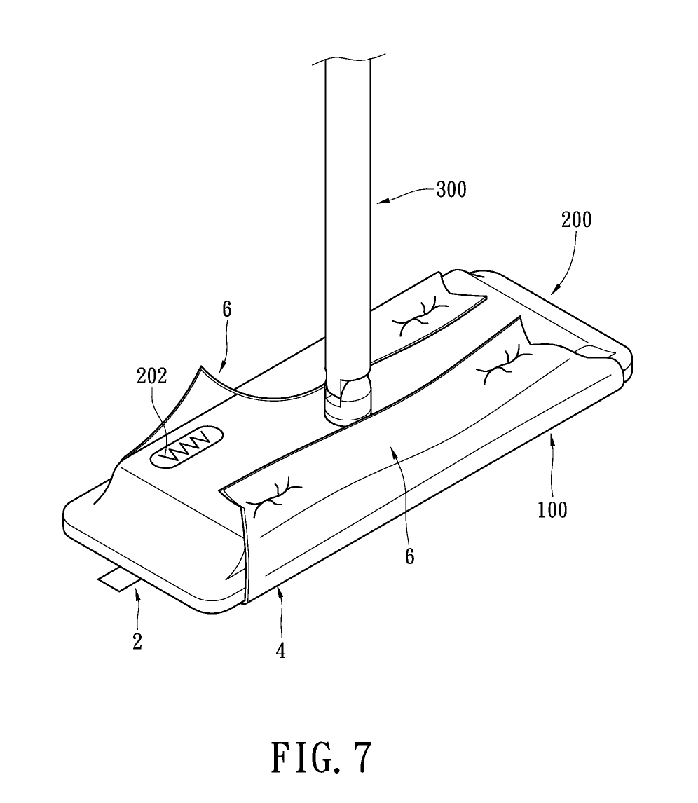

The cleanser-hosting wiper head 100 of the instant disclosure can be mounted to a mop or other cleaning tools in forming a cleaning device. For the embodiment shown in FIG. 6, the cleaning device is a mop having a head unit 200 and a shaft unit 300. The head unit 200 is connected to one end of the shaft unit 300, where a plurality of adhesive strips 201 is disposed on the head unit 200. Alternatively, the adhesive strips 201 can be replaced with a plurality of slots 202 as shown in FIG. 7. In particular, the number of adhesive strips 201 and slots 202 are not restricted. Also, different mounting methods can be used such as using clamps. As shown in FIG. 6, the cleanser-hosting wiper head 100 wraps around the head unit 200, with the fixing portions 6 affixing to the adhesive strips 201 in securing the cleanser-hosting wiper head 100. Alternatively, the fixing portions 6 can be mounted onto the slots 202 to secure the cleanser-hosting wiper head 100 onto the head unit 200 as shown in FIG. 7. In wrapping the cleanser-hosting wiper head 100 around the head unit 200, the first wiper layer 4 faces outwardly with the head unit 200 and the shaft unit 300 in forming a cleaning device.

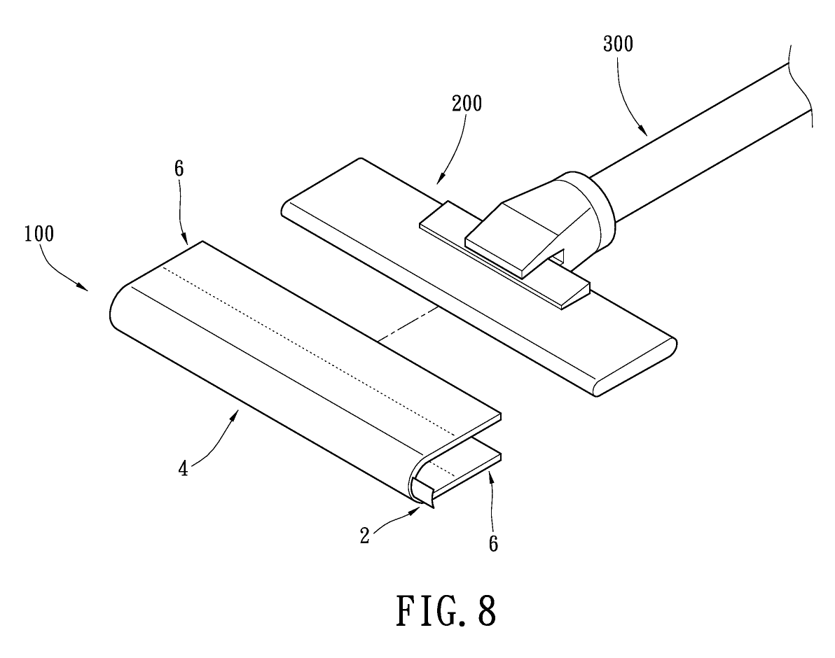

The instant embodiment of FIG. 8 shows a cleaning device as a sweeper, which comprises a head unit 200 and a shaft unit 300. The head unit 200 is attached to one end of the shaft unit 300. The cleanser-hosting wiper head 100 wraps around the head unit 200, with fixing portions 6 affixing to the adhesive strips or slots to secure the cleanser-hosting wiper head 100. Hence, the cleanser-hosting wiper head 100, the head unit 200, and the shaft unit 300 form a cleaning device.

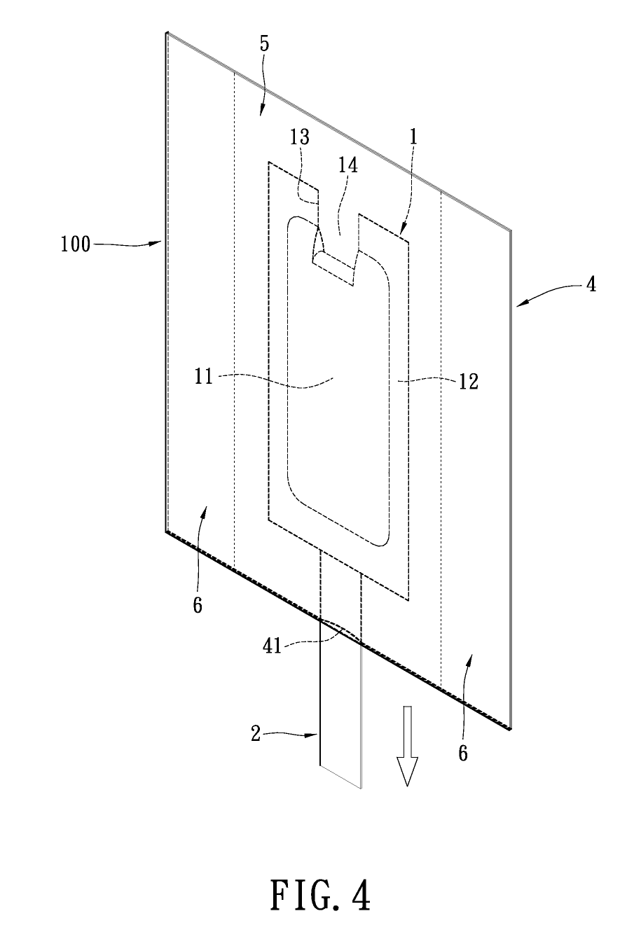

After the cleanser-hosting wiper head 100 is secured to the cleaning device, the user can pull the pulling-tab 2 to tear open the cleanser-hosting pouch 1 by forming an opening 14 as shown in FIG. 4. In turn, the cleanser 11 within the cleanser-hosting pouch 1 is released and infiltrates the first wiper layer 4 to clean the surface. On the other hand, the cleanser-hosting wiper head 100 can be installed inversely to expose the second wiper layer 5 outwardly. The second wiper layer 5, which is dry and not wetted by the cleanser 11, can be used to dry the wetted surface.

For the instant disclosure, the second wiper layer 5 can also be omitted. In turn, the cleanser-hosting wiper head 100 would comprise a cleanser-hosting pouch 1, a pulling-tab 2, an anti-leaking layer 3, and a first wiper layer 4. Thus, only wetting can be performed. Structurally, the cleanser-hosting pouch 1 is disposed in between the anti-leaking layer 3 and the first wiper layer 4, and the anti-leaking layer 3 and the first wiper layer 4 are joined together in forming at least one fixing portion 6.

The instant disclosure has the following advantages. First, the cleanser-hosting wiper head 100 can be affixed to the cleaning device such as a mop or a sweeper. The cleanser-hosting wiper head 100 has an effectively simplified structure, is light-weight, easy-to-use, and has a cleanser-hosting pouch 1 for the cleanser 11. The cleanser 11 can be quickly and evenly released and infiltrates the first wiper layer 4 for cleaning purposes. Secondly, the instant disclosure comprises a second wiper layer 5 for the cleanser-hosting wiper head 100. The second wiper layer 5 adds the drying capability in drying the wetted surface. Thus, the cleanser-hosting wiper head 100 is dual-purposed.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A cleanser-hosting wiper head for a cleaning device, comprising:
a cleanser-hosting pouch having at least one tear-able liquid exit portion for dispensing liquid cleanser;
an anti-leaking layer stacked to one side of the cleanser-hosting pouch;
a first and a second wiper layers sandwiching the cleanser-hosting pouch and the anti-leak layer, wherein the edges of the wiper layers are joined to form a stacked structure.

2. The wiper head of claim 1, further comprising at least one pulling-tab connected to the tear-able liquid exit portion for dispensing the liquid cleanser.

3. The wiper head of claim 2, wherein the pulling-tab is accessibly exposed outside the stacked structure.

4. The wiper head of claim 1, wherein the wiper layer further comprises at least one fixing portion for disposing on the cleaning device.

5. A cleanser-hosting wiper head for a cleaning device, comprising:
a cleanser-hosting pouch having at least one tear-able liquid exit portion for dispensing liquid cleanser;
an anti-leaking (water proof) layer stacked to one side of the cleanser-hosting pouch; and
at least one wiper layer enclosing the cleanser-hosting pouch and the anti-leaking layer, wherein the edges of the wiper layer and the anti-leaking layer are joined to form a stacked structure.

6. The wiper head of claim 5, further comprising at least one pulling-tab connected to the tear-able liquid exit portion for dispensing the liquid cleanser.

7. The wiper head of claim 6, wherein the pulling-tab is accessibly exposed outside the stacked structure.

8. The wiper head of claim 5, wherein the wiper layer further comprises at least one fixing portion for disposing on the cleaning device.

9. A cleaning device, comprising:
a shaft unit;
a head unit connected to the shaft unit; and
a cleanser-hosting wiper head disposed on the head unit, the wiper head comprising:
a cleanser-hosting pouch having at least one tear-able liquid exit portion for dispensing liquid cleanser;
an anti-leaking layer stacked to one side of the cleanser-hosting pouch;
at least one wiper layer enclosing the cleanser-hosting pouch and the anti-leaking layer, wherein the edges of the wiper layer and the anti-leaking layer are joined to form a stacked structure;

10. The cleaning device of claim 9, further comprising at least one pulling-tab connected to the tear-able liquid exit portion for dispensing the liquid cleanser.

11. The cleaning device of claim 10, wherein the pulling-tab is accessibly exposed outside the stacked structure.

12. The cleaning device of claim 9, wherein the wiper layer further comprises at least one fixing portion for disposing on the cleaning device

13. The cleaning device of claim 9, further comprising at least one adhesive strip is disposed on the head unit for securing the wiper head.

14. The cleaning device of claim 9, further comprising at least one slot on the head unit for securing the wiper head.
